(19) United States
(12) Patent Application Publication
(10) Pub. No.: US 2020/0364955 A1
(43) Pub. Date: Nov. 19, 2020

(54) SYSTEM AND METHOD FOR DETERMINING A CAUSE OF ERROR IN AN AGRICULTURAL WORKING MACHINE

(71) Applicant: CLAAS Selbstfahrende Erntemaschinen GmbH, Harsewinkel (DE)

(72) Inventors: Christoph Thöle, Holdorf (DE); Patrick Venherm, Sassenberg (DE); Thilo Dasenbrock, Vechta (DE)

(73) Assignee: CLAAS Selbstfahrende Erntemaschinen GmbH, Harsewinkel (DE)

(21) Appl. No.: 16/869,979

(22) Filed: May 8, 2020

(30) Foreign Application Priority Data
May 14, 2019 (DE) DE 102019112569.3

(51) Int. Cl. G07C 5/08; G07C 5/00

(52) U.S. Cl. CPC G07C 5/0808; G07C 5/008

(57) ABSTRACT

A method and system for determining a cause of error in an agricultural working machine with a faulty component is disclosed. An analysis routine may analyze various types of data, such as operating data of the agricultural working machine, including workload data of the agricultural working machine, and/or design data of the agricultural working machine, such as design data of the faulty component of the agricultural working machine, in order to determine a cause of error, as indicated by cause of error data. Specifically, the analysis routine may analyze one or both of operating data and design data in order to determine whether a workload of the agricultural working machine and/or a design of the agricultural working machine, such as the design of the faulty component of the agricultural working machine, can be excluded and/or identified as the cause of error.

### CROSS REFERENCE TO RELATED APPLICATION

This application claims priority under 35 U.S.C. § 119 to German Patent Application No. DE 102019112569.3 (filed May 14, 2019), the entire disclosure of which is hereby incorporated by reference herein.

### TECHNICAL FIELD

The present invention relates to a method and apparatus for determining a cause of error in an agricultural working machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Repairs of agricultural working machines are frequently laborious and expensive. In particular, during a harvesting period, costs include repair costs and costs due to downtime of the inoperable agricultural working machine. In principle, errors in agricultural working machines may be traced to internal and external causes of errors. Identifying these causes of errors is important on many levels. If the cause of the error is known, such errors may possibly be avoided in the future. At the same time, eliminating the error may also be made more cost-efficient if replacement parts do not have to be ordered and tried out.

Previously, causes of errors in agricultural working machines were determined based on the experience of the particular workshop and perhaps additional cumulative experience, for example on the part of the manufacturer.

### DESCRIPTION OF THE FIGURES

The present application is further described in the detailed description which follows, in reference to the noted plurality of drawings by way of non-limiting examples of exemplary implementation, in which like reference numerals represent similar parts throughout the several views of the drawings, and wherein:

FIG. 1 illustrates a block diagram for collecting and analyzing data using the disclosed methodology with disclosed computer system.

### DETAILED DESCRIPTION

The methods, devices, systems, and other features discussed below may be embodied in a number of different forms. Not all of the depicted components may be required, however, and some implementations may include additional, different, or fewer components from those expressly described in this disclosure. Variations in the arrangement and type of the components may be made without departing from the spirit or scope of the claims as set forth herein. Further, variations in the processes described, including the addition, deletion, or rearranging and order of logical operations, may be made without departing from the spirit or scope of the claims as set forth herein.

As discussed in the background, causes of errors in agricultural working machines were determined based on the experience of the particular workshop and perhaps additional cumulative experience. However, these considerations are usually retrospective in nature without having the actual data on the cause of error.

In this regard, in one or some embodiments, a methodology is disclosed for determining causes of errors in agricultural working machines in order to render determining a cause of error in an agricultural working machine more effective. For example, a method or apparatus (such as a processor in combination with a memory) may perform the following: access design data associated with the agricultural working machine, the design data including design data associated with the faulty component; access operating data of the agricultural working machine, the operating data of the agricultural working machine including workload data; and analyze, by an analysis routine, the design data including design data associated with the faulty component and the operating data of the agricultural working machine including workload data in order to generate cause of error data, the cause of error data indicative of whether one or both of a workload of the agricultural working machine or a design of the faulty component of the agricultural working machine are one or both of excluded or identified as the cause of error.

First of all, operating data and/or design data of the agricultural working machine can help identify whether the error is traceable to the workload (e.g., to operation of the agricultural working machine) and/or to the design of the agricultural working machine. In turn, this makes it possible, for example, to refrain from an error-causing workload (e.g., to refrain from operating the agricultural working machine in a manner that causes an error), and/or to eliminate a design flaw. Moreover, this may allow acceleration of repairs to the agricultural working machine.

In particular, a method is disclosed for determining a cause of error in an agricultural working machine with a faulty component. As disclosed, cause of error data are determined in an analysis routine based on one or both of: operating data of the agricultural working machine (which may comprise workload data); and design data at least comprising component design data assigned to the agricultural working machine. As disclosed, the methodology may determine, based on the analysis routine, whether a workload and/or a design of the agricultural working machine (e.g., a faulty component) may be excluded (e.g., identify operation of the agricultural working machine in a certain manner that causes an error and prevent such operation) and/or identified as a cause of error (e.g., identify a defective part in the agricultural working machine). In this way, the analysis routine may access operating data and/or design data in order to analyze one or both of the operating data or design data to generate the cause of error data, with the cause of error data indicative of whether one or both of a workload of the agricultural working machine or a design of the faulty component of the agricultural working machine are one or both of excluded or identified as the cause of error. As one example, the cause of error data generated by the analysis routine may be indicative that both of the workload of the agricultural working machine and the design of the faulty component of the agricultural working machine are excluded as the cause of error. As another example, the cause of error data generated by the analysis routine may be indicative that both of the workload of the agricultural working machine and the design of the faulty component of the agricultural working machine are identified as the cause of error. As yet another example, the cause of error data generated by the analysis routine may be indicative that only one of the workload of the agricultural working machine or the design of the faulty component of the agricultural working machine is identified as the cause of error.

In one or some embodiments, the analysis routine may determine the cause of error data based on aggregated operating data and/or aggregated design data. Specifically, aggregated operating data from a plurality of agricultural working machines (e.g., agricultural working machines that are not currently faulty), and/or aggregated design data assigned to the plurality of agricultural working machines can be used to determine the cause of error data. The advantage of this is that, when there is a large amount of data, one can better distinguish between random and systematic effects, and hidden interdependencies can be better identified. This increases the possibility of isolating the cause of error in the component.

In one or some embodiments, environmental data and/or aggregated environmental data are may be considered by the analysis routine in determining the cause of error data. For example, the environmental data and/or the aggregated environmental data may comprise any one, any combination, or all of: weather data; geographic data; climate data; harvesting data (e.g., harvesting period data); microdata (e.g., the direct environment of an associated agricultural working machine such as a field to be worked for the associated agricultural working machine); or microdata (e.g., data from a plurality of agricultural working machines). Since the agricultural working machines are in direct contact with the weather and soil of their particular locality, their operation may be strongly influenced by their respective environment. For example, a cutting unit wears significantly faster in rocky soil than in loamy soil. By accounting for these effects, the analysis routine may reconcile the component error profile with the environmental influences of the locality and thereby better narrow down the actual cause of error.

In one or some embodiments, the analysis routine may use cause of error data, such as test data assigned to the agricultural working machine. In this way, test data may be considered by the analysis routine.

Further, in its analysis, the analysis routine may use workload data, which may comprise any one, any combination, or all of: a number of operating hours; motor load data; boost pressure characteristics; coolant water temperature characteristics; exhaust temperature characteristics of the agricultural working machine; or a component of the agricultural working machine (such as a faulty component). Alternatively, or in addition, in its analysis, the analysis routine may use operating data, which may comprise any one, any combination, or all of: configuration and parameter setting data; changed configuration and parameter setting data; calibration data; or error data (e.g., an error type and/or error frequency of the agricultural working machine and/or a component of the agricultural working machine (such as the faulty component).

Further, in its analysis, the analysis routine may use design data, which may comprise any one, any combination, or all of: identification data (e.g., series data, and/or manufacturer data); or technical features (e.g., material data of the agricultural working machine and/or a component of the agricultural working machine (such as the faulty component). Thus, the analysis routine may use various combinations of the environmental data, the operating data and/or the design data.

In one or some embodiments, the operating data in this case may be generated by sensors during operation of the agricultural working machine. In particular, the operating data may be particularly suitable for depicting various potentially error-causing influences on the agricultural working machine. In this regard, the agricultural working machine may have at least one sensor, with the operating data being generated by the at least one sensor during operation of the agricultural working machine.

In one or some embodiments, the determined cause of error may comprise error chains. Specifically, such error chains may occur in agricultural working machines when for example an error in a component is caused by an error in another component. Accordingly, these error chains may provide indications of whether the faulty component is only the last link in a chain of faulty components, or whether it is actually responsible for the error in the first instance. Thus, the analysis routine may determine whether the error is due to an error chain and/or may identify the error chain as a cause of error. In particular, the analysis routine may determine the cause of error data as comprising operating data assigned to the error chains (e.g., workload data), specifically determining whether this operating data may be excluded and/or identified as the cause of error.

In one or some embodiments, the analysis routine may determine whether a material flaw in the faulty component (e.g., a defect in the material of the faulty component) can be excluded as the cause of error and/or identified as a cause of error. Further, the analysis routine may determine the cause of error data based on analysis data (such as the material analysis data, which may be assigned to the faulty component and collected after the occurrence of the error). In this way, the analysis routine may determine whether a material error of the faulty component can be excluded and/or identified as a cause of error. On the basis of this analysis performed by the analysis routine, qualified decisions can then be made with regard to exchanging the faulty component. Specifically, the analysis routine may determine based on the material analysis data whether a material flaw in the faulty component is excluded and identified as the cause of error.

In one or some embodiments, a most universally usable diagnostic device is disclosed, with the diagnostic device collecting operating data for later analysis. For example, diagnostic device(s) may collect the operating data, such as test data, with the diagnostic device(s) assigned to the agricultural working machine at issue (e.g., subject to the present error) and/or the plurality of agricultural working machines (e.g. other than the agricultural working machine subject to the present error). The diagnostic device may be connected to the agricultural working machine, with the diagnostic device collecting heterogeneous operating data (e.g., heterogeneous test data) from different component manufacturers and/or different component series. Thus, the diagnostic device, connected to the agricultural working machine, may collect data in order to prepare a diagnosis of the agricultural working machine, with the operating data from the diagnostic device be transmitted to the agricultural working machine when the diagnostic device is connected to the agricultural working machine (e.g., the diagnostic device determines the test data when the diagnostic device is connected to the agricultural working machine). In this regard, the diagnostic device may collect heterogeneous operating data that may originate from different component manufacturers and/or different component series, with the heterogeneous operating data populating a useful database.

In one or some embodiments, the analysis routine may determine whether a control system of the agricultural working machine (such as a software control system of the agricultural working machine) or a component of the agricultural working machine (such as a faulty component of the agricultural working machine) may have possibly facilitated the error of the faulty component. In response to the analysis routine determining that the faulty component was due to an error in the control system (such as an error in the software control system), separate from replacing the faulty component, the control system (such as the software control system) may be subjected to a software update (in order to prevent future errors).

In one or some embodiments, responsive to the analysis routine identifying the root cause of the error, repair and/or servicing may be scheduled and/or initiated for other agricultural working machines having a component with a somewhat equivalent design (such as at least with respect to the faulty component, including the same component that was faulty). Thus, identifying the cause of error data may cause proactive repair or servicing of other agricultural working machines by using aggregated cause of error data. In this way, the obtained cause of error data may be used in order to schedule repair and/or servicing for other agricultural working machines of the same type.

In one or some embodiments, the analysis routine may determine whether a combination of different factors contributes to the error, such as any one, any combination, or all of: at least two components that are included in the agricultural working machine; a combination of at least one component that is included in the agricultural working machine with at least one environmental state of the agricultural working machine; a combination of at least one component that is included in the agricultural working machine with a profile of a user (that may be derivable from the operating data). This is in contrast to identifying or excluding the cause of error due to a single component of the agricultural working machine. This may thus account for the fact that many errors only arise in certain configurations.

In one or some embodiments, a computer system may be configured to perform part or all of the analysis routine. For example, the computer system may perform any one, any combination, or all of: determine the aggregated operating data from the operating data of the plurality of agricultural working machines; determine the aggregated design data from design data from the plurality of agricultural working machines; may include a web application, through which a user may retrieve the results of determining the cause of error. Thus, because of the amount of data, the computer system may perform the analysis without requiring manual analysis of the data.

Referring to the figures, the disclosed methodology may be used for an agricultural working machine 1. Agricultural working machine 1 may be a harvesting machine such as a combine or the like. Further, the disclosed methodology may be performed at least partially by a computer system 2. The computer system 2 may comprise one or more servers 3.

The disclosed methodology may assist in determining a cause of error of the agricultural working machine 1 that has a faulty component 4. The disclosed methodology comprises an analysis routine, which may be performed by the computer system 2.

The analysis routine may determine cause(s) of error data based on one or both of operating data of the agricultural working machine 1, with the operating data comprising workload data, and design data, which may comprise design data of the faulty component 4 assigned to the agricultural working machine 1. The analysis routine may determine whether a workload and/or a design of the agricultural working machine 1 (such as the design of the faulty component 4), may be excluded as the cause of error and/or may be identified as the cause of error. The analysis routine may determine the faulty component 4 in a first method step, and may determine, in a subsequent method step, whether the workload and/or the design of the faulty component 4 can be excluded and/or identified as a cause of error.

The faulty component 4 of the agricultural working machine 1 may, for example, be a drive motor 5, a component of the drive motor 5 and/or a harvesting tool (e.g., a cutting tool 6 of the agricultural working machine 1).

Subsequently, in one or some embodiments, the analysis routine may access a database in order to determine potential causes of error and measures for troubleshooting.

In one or some embodiments, the analysis routine may determine the cause of error data based on a plurality of aggregated operating data assigned to other agricultural working machines 1 (e.g., other agricultural working machines that are different from the specific agricultural working machine that is subject to error) and/or the aggregated design data assigned to the plurality of agricultural working machines 1.

The term “plurality” is to be understood as meaning that there also can in fact be just more than one other agricultural working machine 1, but the plurality of agricultural working machines 1 preferably comprises at least 100, more preferably at least 500, and even more preferably at least 1000 other agricultural working machines 1. In particular, the plurality of agricultural working machines 1 may be globally distributed. This means that the plurality of agricultural working machines 1 preferably comprises at least one agricultural working machine 1 from two countries, more preferably at least from five countries, and even more preferably from at least two continents.

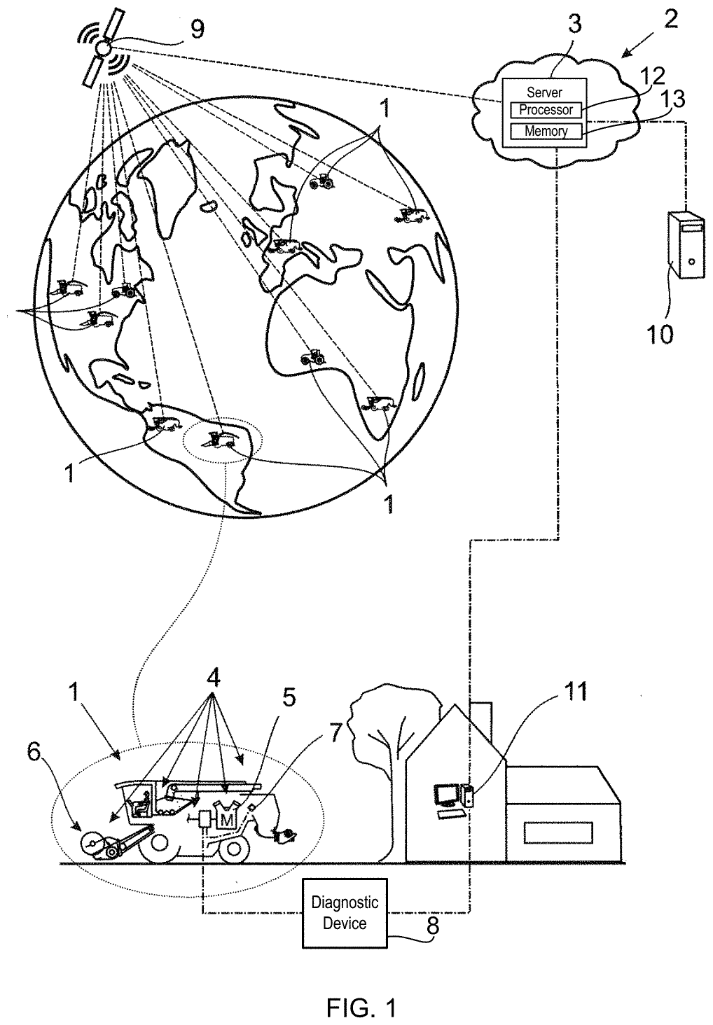

As shown in FIG. 1, a plurality of agricultural working machines 1 that are globally distributed may be present. As will be explained below, the operating data from this plurality of agricultural working machines 1 may be transmitted to the server 3. The data from the plurality of agricultural working machines 1 can then be processed into the aggregated operating data using data processing methods, such as big data analysis. For example, statistical and/or pattern recognition methods may be used for this big data analysis. From these aggregated operating data, conclusions about processes during the operation of the agricultural working machine 1 may then be drawn, such as automatically determined by the computer system 2. To accomplish this, the operating data from the agricultural working machine 1 may be incorporated in the process of aggregating the operating data from the plurality of agricultural working machines 1, or may be subsequently compared therewith. The type of data aggregation described here may equally be applied to the other data types yet to be described or already described.

The normal operating cycle of an agricultural working machine 1 is initiated when agricultural working machine 1 is purchased. The agricultural working machine 1 is subsequently operated, during which the operating data accrue, and is serviced on schedule. The disclosed methodology is for configuring new operating cycles of new agricultural working machines 1 more efficiently and economically by using data from the old operating cycles.

In the following with reference to FIG. 1, the data that preferably can be taken into account in the analysis routine and their origin will be described in greater detail with reference to one or some embodiments.

The operation of an agricultural working machine 1 can vary widely depending on the environment. For example, the air pressure at sea level can influence the functioning of the drive motor 5 differently than the air pressure at 3000 meters above sea level; on a sunny day, an agricultural working machine 1 can be exposed to high temperatures on a field to be harvested. Given the necessity of bringing in the harvest, the agricultural working machine 1 can also be used under extreme weather conditions. Moreover, use on a field on a slope requires significantly different features that on a field in a floodplain. Accordingly, in one or some embodiments, the analysis routine may determine the cause of error data based on environmental data assigned to the agricultural working machine 1 and/or the plurality of aggregated environmental data assigned to the plurality of agricultural working machines 1.

The environmental data and/or the aggregated environmental data may comprise any one, any combination, or all of: weather data; geographic data; climate data; or harvesting data (e.g., harvesting period data). Alternatively or in addition, the environmental data may comprise microdata and/or macrodata.

The microdata concern the direct environment of the agricultural working machine 1, such as the particular field to be worked, and the macrodata at least potentially concern a plurality of agricultural working machines 1. The microdata may, for example, comprise the information that a field to be worked at a certain point in time is very rocky, whereas the macrodata may, for example, comprise the information that agricultural working machines 1 close to the equator are exposed to higher temperatures. To do this, it is not absolutely necessary for a plurality of agricultural working machines 1 to actually be close to the equator; however, significantly more agricultural working machines 1 may at least be potentially close to the equator than are to be expected on an individual field.

The environmental data may comprise at least one data set not collected by an agricultural working machine 1. More specifically, at least the macrodata, such as part or of all the environment data, may originate from external data sources with respect to the agricultural working machines 1. More preferably, the external data sources are also not directly assigned to the agricultural working machines 1. This is for example the case with weather data from a weather service.

As shown in FIG. 1, a plurality of agricultural working machines 1 may exist that are globally distributed and can contribute to the aggregated operating data. From this aggregated operating data, conclusions about processes during the operation of the agricultural working machine 1 may be drawn, such as automated by the computer system 2.

In one or some embodiments, the workload data comprise any one, any combination, or all of: a number of operating hours; motor load data; boost pressure characteristics; coolant water temperature characteristics; exhaust temperature characteristics of the agricultural working machine 1; a component 4 of the agricultural working machine 1 (e.g., the faulty component 4); a rotational speed at certain points in time; a maximum rotational speed, exceeding a maximum payload; and more of the same.

In addition or alternatively, the operating data may comprise any one, any combination, or all of: configuration and parameter setting data; changed configuration and parameter setting data; or calibration data. More particularly, the operating data at least comprise error data (e.g., an error type and/or error frequency). Generally speaking, the operating data and/or the aggregated operating data can always refer to the corresponding agricultural working machine 1 and/or at least one component 4, in particular the faulty component 4 of the agricultural working machine 1.

In one or some embodiments, at least one sensor 7 of the agricultural working machines 1 may generate and collect the operating data are collected during operation of the agricultural working machines 1.

As disclosed, the analysis routine may determine the cause of error data (e.g., the analysis routine may make a determination as to the cause of the error) based on design data assigned to the agricultural working machine 1. This design data may comprise any one, any combination, or all of: identification data (e.g., series data, and/or manufacturer data); technical features of the agricultural working machine 1; or a component of the agricultural working machine 1 (e.g., the faulty component 4).

Since agricultural working machines 1 are complex systems, it can happen that errors in one component 4 may also affect other components 4. Such dependencies can be evident, but frequently they are not. Such frequently occurring error chains may only be exposed by evaluating the data from the plurality of agricultural working machines 1. Correspondingly, the determined cause of error data may comprise error chains that occurred in the same faulty components 4 of the plurality of agricultural working machines 1.

With interlinked errors, it may be particularly important to determine the causes of errors. If the original error is not eliminated, this may manifest itself in recurring, sometimes obscure, error profiles. In one or some embodiments, the analysis routine may determine whether such an error chain can be excluded and/or identified as a cause of error.

The analysis routine may analyze the actual processes before and during the occurrence of the error since in this case error codes from the agricultural working machine 1 can be subsequently read out, and the determined cause of error data can comprise operating data assigned to the error chains, in particular workload data. Thus, the analysis routine may determine whether this operating data can be excluded and/or identified as a cause of error.

The above description shows that it is generally advantageous when the operating data from the agricultural working machine 1 (e.g., the workload data) refer to a point in time before or during the occurrence of the error.

Alternatively or in addition, the analysis routine may determine whether a material flaw in the faulty component 4 can be excluded and/or identified as a cause of error. In particular for this purpose, the analysis routine may determine the cause of error data based on analysis data, such as material analysis data assigned to the faulty component 4 and collected after the occurrence of the error. This analysis data may, for example, be determined in a workshop or in a laboratory as well.

As portrayed in FIG. 1, the data mentioned above can originate from completely different sources. In this case and preferably, the operating data originate from a diagnostic device 8 that will be explained below, whereas the environmental data may originate from another data source, such as satellite 9. In this case, the design data again may originate from another source, such as from another server 10.

As previously mentioned, the operating data from the agricultural working machine 1 and/or the plurality of agricultural working machines 1 may be collected from a diagnostic device 8. This diagnostic device 8 may be connected to an agricultural working machine 1 in the context of servicing, for example annual servicing. In one or some embodiments, the diagnostic device 8 is not assigned to a special agricultural working machine 1 but can be removably connected to and disconnected from a least more than one agricultural working machine 1. Correspondingly, the diagnostic device 8 may collect heterogeneous operating data, in particular from different component manufacturers and/or different component series.

In this case, the diagnostic device 8 may be connected to the agricultural working machine 1 in order to prepare a diagnosis of the agricultural working machine 1. The operating data may be collected while the diagnostic device 8 is connected to the agricultural working machine 1. Alternatively or in addition, the operating data from the diagnostic device 8 are received by the agricultural working machine 1 when the diagnostic device 8 is connected to the agricultural working machine 1. It may also be provided that the diagnostic device 8 collects test data while it is connected to the agricultural working machine 1. To accomplish this, the diagnostic device 8 may control the agricultural working machine 1 to perform the test routines.

In one or some embodiments, the operating data collected from the agricultural working machine 1 are transmitted to the diagnostic device 8 which may subsequently be connected to (or in communication with) a computer 11 that then transmits the operating data to the server 3.

To protect from unauthorized changes, the operating data may be protected using blockchain technology. To accomplish this, the agricultural working machine 1 may save data as a blockchain, the diagnostic device 8 may then add its own data thereto, and the server 3 may then check if the data are coherent.

Control systems play an ever-increasing role in increasingly more complex agricultural working machines 1. It is therefore possible for agricultural working machines 1 that actually function smoothly to only be damaged by faulty interventions from a control system (e.g., the control system is the underlying cause of the error). Accordingly, in one or some embodiments, the analysis routine may determine whether a control system, such as a software control system of the agricultural working machine 1, or of a component 4 of the agricultural working machine 1, such as the faulty component 4 of the agricultural working machine 1, may be excluded or identified as the cause of error.

Software control systems may frequently be accessed or updated via a software update. Accordingly, the software control system may be modified via a software update so that other identical errors are prevented or reduced. In particular, this is done for the plurality of agricultural working machines 1 (separate from the agricultural working machine that was subject to the error) so that other errors are economically prevented or reduced.

In general, repair and/or servicing may be planned and/or initiated for other agricultural working machines 1 having a component 4 with a somewhat equivalent design, such as with respect to the faulty component 4, on the basis of the cause of error data and other, in particular aggregated cause of error data from a plurality of other agricultural working machines 1. This may prevent or reduce expensive errors.

Errors may not always be traceable to individual causes. Given the existence of data from the plurality of agricultural working machines 1, conclusions about correlations between the occurrence of the errors and possible causes can however be determined. Consequently, the analysis routine may determine whether combinations of at least two components 4 that exist in some of the plurality of agricultural working machines 1 may be identified and or excluded as a cause of error. In addition or alternatively, the analysis routine may determine whether combinations of at least one component 4 with at least one environmental state that exists in the environmental data, and/or combinations of at least one component with a usage profile of a user that is derivable from the operating data, can be identified and/or excluded as a cause of error.

The usage profile of the user may reflect the manner in which the agricultural working machine 1 is operated, such as indicative of frequent overloading or the like. Alternatively, or in addition, the usage profile comprises the maintenance of predetermined limit values when operating the agricultural working machine 1.

As previously mentioned, the methodology may be partially or completely performed by a computer system 2 depending on the design. The computer system 2 which is the subject of an independent teaching is preferably configured to perform at least the proposed analysis routine.

The computer system 2 may comprise any type of computing functionality and may include processor 12 and memory 13, which may be resident in server 3. Likewise, other devices, such as additional server 10 and computer 11, may include computing functionality, including one or more processors and one or more memories, such as described herein. In this regard, any discussion regarding computing functionality for the computer system 2 may likewise be applied to additional server 10 and computer 11. Further, in one embodiment, the computing functionality for the computer system 2 is separate from the computing functionality for the additional server 10 and computer 11. Alternatively, the computing functionality for computer system 2 may be integrated with the computing functionality for one or both of additional server 10 and computer 11 (e.g., same processor/memory used in both computer system 2 and one or both of additional server 10 and computer 11).

Though processor 12 (which may comprise a microprocessor, controller, PLA or the like) and memory 13 are depicted as separate elements, they may be part of a single machine, which includes a microprocessor (or other type of controller) and a memory unit. The microprocessor and memory unit are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Accordingly, the circuitry, such as the processor, may store in or access instructions from a memory for execution, or may implement its functionality in hardware alone. The instructions, which may comprise computer-readable instructions, may implement the functionality described herein and may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may include a storage medium and instructions stored in or on the medium, and the instructions when executed by the circuitry in a device may cause the device to implement any of the processing described herein or illustrated in the drawings.

In one or some embodiments, analysis routine may be resident in computer system 2. Alternatively, analysis routine may be resident in another computer, such as in additional server 10 and/or computer 11. Still alternatively, analysis routine may be only partly resident in computer system 2. Computer system 2 may determine the aggregated operating data from the operating data of the plurality of agricultural working machines 1, and/or determine the aggregated design data from the design data of the plurality of agricultural working machines 1. The computer system 2 may have a web application, through which a user may see the results of determining the cause of error. With regard to the computer system 2, reference may be made to all of the statements regarding the disclosed methodology. Due to the complexity of the amounts of data, the computer system 2 may be used. In one or some embodiments, the analysis routine and/or the aggregation of the operating data must be performed in a computing device, such as in computer system 2.

In one or some embodiment, the computer system 2 may not be assigned to a specific agricultural working machine, such as agricultural working machine 1, and may be cloud-based.

It is intended that the foregoing detailed description be understood as an illustration of selected forms that the invention can take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some or all of the steps in the disclosed method are performed using a computer so that the methodology is computer implemented. In such cases, the resulting physical properties model may be downloaded or saved to computer storage.

### LIST OF REFERENCE NUMBERS

1 Agricultural working machine
2 Computer system
3 Server
4 Component
5 Drive motor
6 Cutting tool
7 Sensor
8 Diagnostic device
9 Satellite
10 Additional server
11 Computer
12 Processor
13 Memory

1. A computer-implemented method for determining a cause of error in an agricultural working machine with a faulty component, the method comprising:
accessing design data associated with the agricultural working machine, the design data including design data associated with the faulty component;
accessing operating data of the agricultural working machine, the operating data of the agricultural working machine including workload data; and
analyzing, by an analysis routine, the design data including design data associated with the faulty component and the operating data of the agricultural working machine including workload data in order to generate cause of error data, the cause of error data indicative of whether one or both of a workload of the agricultural working machine or a design of the faulty component of the agricultural working machine are one or both of excluded or identified as the cause of error.

2. The method of claim 1, wherein the analysis routine determines the cause of error data based on one or both of a plurality of aggregated operating data assigned to other agricultural working machines or aggregated design data assigned to the other agricultural working machines.

3. The method of claim 2, wherein the analysis routine determines the cause of error data based on both environmental data assigned to the agricultural working machine and aggregated environmental data assigned to the plurality of agricultural working machines;
wherein the environmental data and the aggregated environmental data comprise any one, any combination, or all of: weather data; geographic data; climate data; or harvesting data including harvesting period data;
wherein the environmental data assigned to the agricultural working machine comprise microdata indicative of a field worked by the agricultural working machine; and
wherein the aggregated environmental data comprises macrodata associated with the plurality of agricultural working machines.

4. The method of claim 3, wherein the analysis routine determines the cause of error data based on test data assigned to the agricultural working machine.

5. The method of claim 1, wherein the workload data comprise any one, any combination, or all of: a number of operating hours; motor load data; boost pressure characteristics; coolant water temperature characteristics; or exhaust temperature characteristics of the agricultural working machine.

6. The method of claim 1, wherein the operating data comprise any one, any combination, or all of: configuration and parameter setting data; changed configuration and parameter setting data; calibration data; or error data including one or both of error type or error frequency of the faulty component of the agricultural working machine.

7. The method of claim 1, wherein the analysis routine is configured to determine the cause of error data by determining whether an error chain is excluded or identified as the cause of error.

8. The method of claim 7, wherein the analysis routine analyzes operating data assigned to the error chains for the plurality of agricultural working machines in order to determine whether the operating data is excluded or identified as the cause of error.

9. The method of claim 1, further comprising collecting, after occurrence of the error, material analysis data associated with the faulty component; and
wherein the analysis routine determines based on the material analysis data whether a material flaw in the faulty component is excluded and identified as the cause of error.

10. The method of claim 1, further comprising collecting, using one or more diagnostic devices, heterogeneous operating data, including heterogeneous test data, from one or both of different component manufacturers or different component series; and
wherein the analysis routine analyzes the heterogeneous operating data, including the heterogeneous test data, in order to generate the cause of error data.

11. The method of claim 10, wherein the one or more diagnostic devices comprise a diagnostic device connected to the agricultural working machine in order to generate test data for a diagnosis of the agricultural working machine; and
wherein the test data generated by the diagnostic device is received by the agricultural working machine when the diagnostic device is connected to the agricultural working machine.

12. The method of claim 1, wherein the agricultural working machine comprises a software control system that controls operation of the faulty component; and
wherein the analysis routine generates the cause of error data indicative of whether the software control system of the agricultural working machine is excluded or identified as the cause of error.

13. The method of claim 12, further comprising modifying the software control system using a software update such that other equivalent errors are prevented or reduced.

14. The method of claim 1, further comprising, responsive to generating the cause of error data, initiating a repair or servicing for other agricultural working machines having a component of equivalent design to the faulty component.

15. The method of claim 1, wherein the analysis routine determines whether combinations of any one, any combination, or all of the following as being identified or excluded as the cause of error: at least two components that exist in the plurality of agricultural working machines; a combination of at least one component of the agricultural working machine with at least one environmental state that exists in environmental data operating the agricultural working machine; or a combination of at least one component of the agricultural working machine with a usage profile of a user that is derived from operating data for the agricultural working machine.

16. The method of claim 1, wherein the cause of error data generated by the analysis routine is indicative that both of the workload of the agricultural working machine and the design of the faulty component of the agricultural working machine are excluded as the cause of error.

17. The method of claim 1, wherein the cause of error data generated by the analysis routine is indicative that both of the workload of the agricultural working machine and the design of the faulty component of the agricultural working machine are identified as the cause of error.

18. The method of claim 1, wherein the cause of error data generated by the analysis routine is indicative that only one of the workload of the agricultural working machine or the design of the faulty component of the agricultural working machine is identified as the cause of error.

19. A computer system comprising:
a memory; and
a processor in communication with the memory, the processor executing instructions in the memory to:
determine aggregated operating data from operating data of a plurality of agricultural working machines;
determine aggregated design data from design data from the plurality of agricultural working machines; and
analyze the aggregated operating data and the aggregated design data in order to generate cause of error data, the cause of error data indicative of whether one or both of a workload of an agricultural working machine or a design of a faulty component of the agricultural working machine are excluded or identified as the cause of error.

20. The computer system of claim 19, wherein the processor is further configured to function as a web application through which a user retrieve the cause of error data.
